(19) United States
(12) Patent Application Publication
(10) Pub. No.: US 2003/0043142 A1
(43) Pub. Date: Mar. 6, 2003

(54) IMAGE INFORMATION TRANSMISSION SYSTEM

(76) Inventor: YASUHIRO ISHIBASHI, TOKYO (JP)

Correspondence Address: FINNEGAN, HENDERSON, FARABOW, GARRETT &, DUNNER LLP, 1300 I STREET, NW, WASHINGTON, DC, 20006, US

(21) Appl. No.: 09/181,468

(22) Filed: Oct. 28, 1998

(30) Foreign Application Priority Data
Oct. 30, 1997 (JP) 9-298741

(51) Int. Cl. G09G 5/00

(52) U.S. Cl. 345/213

(57) ABSTRACT

During a blanking period of a video signal transmitted from a DVD decoder to a video input port of a VGA controller, display control information, such as video control data or a command, is transmitted to the video input port of the VGA controller through a video signal line for transmitting the video signal. With the transmission of the display control information during the blanking period of a video signal, the display control information can be transmitted through the normal video signal line. Therefore, the display control operations of the display controller, for example, interlace/non-interlace conversion, can be controlled timely without using a special hardware connector.

### BACKGROUND OF THE INVENTION

This application is based on Japanese Patent Application No. 298741/97, filed Oct. 30, 1997, the content of which is incorporated herein by reference.

The present invention relates to a display control apparatus having an animation display function for decoding a series of coded digital-compression video data and displaying the decoded data on a non-interlace display monitor and an animation image decoding apparatus used in the display control apparatus.

In recent years, as the computer and multimedia techniques have progressed, various computer systems applicable to multimedia have been developed. A computer of this type has a function for reproducing animation and voice data, as well as text and graphics data.

Such a computer system may pose a so-called feathering problem as described in a copending application Ser. No. 09/076,726 filed May 13, 1998 by the same applicant.

To solve the problem of feathering and improve the quality of an image of the non-interlace display, it is important to dynamically control the interlace/non-interface conversion by the display controller during the period of display in accordance with the frame structure of contents decoded by the DVD decoder. To transmit display control information to the display controller for this purpose, two methods are considered: one is to use software and the other is to use an exclusive signal line provided between the DVD decoder and the display controller to transmit display control information.

However, in the method of using software, it is necessary to activate exclusive software by generating an interruption signal to the CPU, every time display control information is transmitted. For this reason, there is a possibility that display control information is not timely transmitted to the display controller, depending on the state of the load of the CPU. In this case, if the conversion mode for the interlace/non-interlace conversion, etc., is not switched in time, image deterioration such as feathering may occur in the displayed image.

On the other hand, in the method of using an exclusive signal line for transmitting display control information, it is necessary to additionally provide an exclusive pin for inputting/outputting display control information in each of the DVD decoder and the display controller. Therefore, there are problems that the hardware structure is complicated and that an existing video bus, such as a ZV (Zoomed Video) port, cannot be utilized as an interface for connecting the DVD decoder and the display controller.

### BRIEF SUMMARY OF THE INVENTION

An object of the present invention is to provide a display control apparatus and an animation image decoding apparatus used in the display control apparatus, in which display control information is timely transmitted to a display controller without using a special hardware connector and the image quality of non-interlace display is improved.

To solve the above problem, according to the present invention, there is provided a display control apparatus comprising: a decoder for decoding a series of data which are digital-compression coded and outputting a video signal; a display controller, having a video input port to which the video signal output from the decoder is input, for displaying the video signal input to the video input port based on external display control information; and display control information transmitting means for transmitting the display control information to the video input port of the display controller through a video signal line for transmitting the video signal, during a blanking period of the video signal transmitted from the decoder to the video input port of the display controller.

In the above display control apparatus, during a blanking period of a video signal transmitted from a DVD decoder to a video input port of a VGA controller, display control information, such as video control data or a command, is transmitted to the video input port of the VGA controller through a video signal line for transmitting the video signal. With the transmission of the display control information during the blanking period of a video signal, the display control information can be transmitted through the normal video signal line. Therefore, the display control operations of the display controller, for example, interlace/non-interlace conversion, can be controlled timely without using a special hardware connector.

More specifically, discriminating information representing a structure of data decoded by the decoder or a command generated from the discriminating information is transmitted to the display controller as control information. As a result, the conversion mode for interlace/non-interlace conversion mode can be switched in accordance with the data structure (e.g., frame data or field data). For example, an interpolation mode is used for field data, whereas a field synthesizing mode is used for frame data. Thus, the conversion mode can be dynamically switched.

In the interpolation mode, missing lines of field output from the decoder (odd lines in an even field, and even lines in an odd field) are added by interpolation, thereby generating a piece of frame image from a piece of field image. Hence, it is possible to prevent synthesis of fields having a time difference. As regards frame data, data of the same frame number is divided into a plurality of fields. Therefore, except for the frames including repeat fields, field data of the same frame number are synthesized in the field synthesizing mode, thereby preventing synthesis of fields having a time difference.

When the data decoded by the decoder is a repeat field generated by the 3:2 pull down conversion, it is preferable to inform the display controller of the matter by means of the display control information, thereby excluding the repeat field from a conversion process of the field synthesizing mode executed by the display controller. As a result, the field synthesis is performed, while a repeat field is skipped, so that a repeat field in a frame and a first field of the next frame may not be synthesized into a piece of frame data.

According to the present invention, since the operation for the non-interlace display is controlled by transmitting video control data or commands to the VGA controller through the YUV signal line in a vertical blanking period. Therefore, the display control, such as switching of the conversion mode or skipping of a repeat field, can be performed timely without using a special hardware connector, so that the image quality of the non-interlace display can be realized.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a block diagram showing a basic structure of a computer system according to a first embodiment of the present invention;

FIG. 2 is a diagram showing a structure of a line designation register 112b in a DVD decoder 112 and a line designation register 113a in a VGA controller 113;

FIG. 3 is a diagram showing an example of the data format of video control data transmitted from the DVD decoder to the VGA controller in the computer system of the embodiment;

FIG. 4 is a diagram showing a structure of a video signal output from the DVD decoder used in the computer system of the embodiment;

FIGS. 5A to 5H are timing charts showing transmission timing of video data from the DVD decoder to the VGA controller used in the computer system of the embodiment;

FIG. 6 is a block diagram showing a concrete hardware structure of the system of the embodiment;

FIG. 7 is a diagram showing an example of an animation data recording format used in the system of the embodiment;

FIG. 8 is a diagram showing a structure of a DVD-ROM drive used in the system of the embodiment;

FIG. 9 is a diagram showing interconnection between units in the DVD decoder used in the system of the embodiment;

FIGS. 10A to 10D are timing charts showing an interlace/non-interlace converting operation in the system of the embodiment; and

FIGS. 11A to 11E are timing charts showing a repeat field skip control operation in the system of the embodiment.

### DETAILED DESCRIPTION OF THE INVENTION

An embodiment of the present invention will be described with reference to the accompanying drawings.

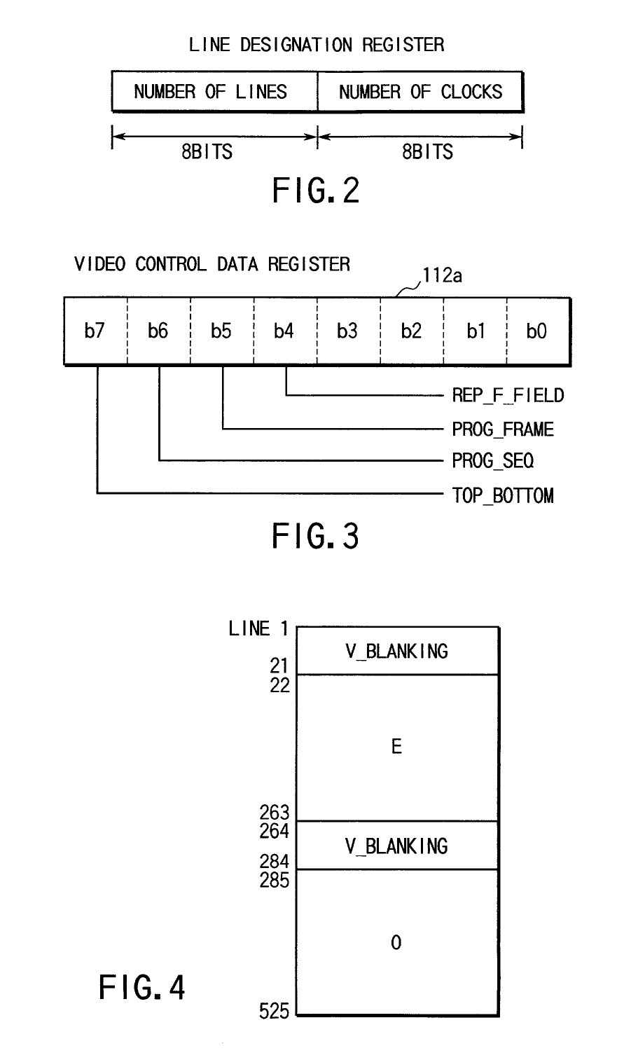

FIG. 2 shows a basic structure of the hardware and software of a personal computer according to an embodiment of the present invention.

The personal computer comprises, as main hardware necessary for reproducing DVD video information, a DVD-ROM drive 111 accessible to both CD-ROM media and DVD-ROM media, a DVD decoder 112 for decoding DVD video information (video, sub-picture and audio data) read from the DVD-ROM drive 111, and a VGA controller 113 for controlling a display monitor (LCD, CRT) of the computer which performs non-interlace display.

A DVD-ROM medium stores video information constituting DVD video titles. Reproduction of the titles on the DVD-ROM medium is controlled by DVD drivers 114, a DVD application program 115 and a video port driver 116. The video port driver 116 is a software driver for controlling a digital video input port of the VGA controller 113.

The DVD drivers 114, which are software drivers for MEPG2 video control, control the DVD-ROM drive 111 and the DVD decoder 112 in accordance with instructions from the DVD application program 115, and transfer video information from the DVD-ROM drive 111 to the DVD decoder 112.

The video information transferred from the DVD-ROM drive 111 to the DVD decoder 112 is constituted by an MPEG2 program stream, including coded video, sub-picture and audio data.

The video data transferred by the MPEG2 program stream are classified into two kinds, as described above: data constituted by progressive-scanned frame data (progressive data) coded at a frame rate of 24 Hz like movie film, and data constituted by field data coded at a rate of 60 Hz.

The MPEG2 program stream includes discrimination information flags showing the respective data structures, so that the DVD decoder 112 can correctly decode the two kinds of video data. The flags are Top/Bottom flag, Progressive Sequence Flag, Progressive Frame Flag, Repeat First Field Flag, etc.

The Top/Bottom flag represents whether the field is of the higher or lower order as compared to a next field to be decoded, i.e., whether the field is a top field or bottom field. For example, if an even field is ahead of an odd field, the even field is a Top field and the odd field is a Bottom field.

The Progressive Sequence flag represents whether next video data to be decoded is progressive sequence data.

The Progressive Frame flag represents whether video data to be decoded is constituted by frame data of the progressive sequence, i.e., frame data coded at the frame rate of 24 Hz (progressive data). The Progressive Frame flag=1 represents that video data to be decoded is frame data coded at the frame rate of 24 Hz (progressive data), and the Progressive Frame flag=0 represents that video data to be decoded is field data as described before.

The Repeat First Field flag is used to control the 3:2 pull down conversion. The Repeat First Field=1 represents that a repeat field the same as the first field is to be output next.

The DVD decoder 112 includes a video control data register 112a, in which the contents of the Top/Bottom flag, Progressive Sequence Flag, Progressive Frame Flag and Repeat First Field Flag, extracted from the MPEG2 program stream, are set. The video control data register 112a is used to control the decoding operation of the DVD decoder 112 and inform the VGA controller 113 from what data the decoded video data output from the DVD decoder 112 is generated.

The DVD decoder 112 further includes a line designation register 112b. As shown in FIG. 2, the line designation register 112b includes a field designating the number of lines and a field designating the number of clocks, so as to programmably set where the contents of the respective flags set in the video data control register 112a should be inserted (which of the vertical retrace lines and which of the clocks of the line).

The video data decoded by the DVD decoder 112, for use in the interlace display, is directly input to the digital video input port of the VGA controller 113 through an exclusive video bus. The video bus is, for example, a ZV (Zoomed Video) port comprising a digital YUV data signal line having a width of 16 bits corresponding to the 422 image format (luminance data Y of 8 bits and chrominance data UV of 8 bits), and signal lines for transmitting horizontal and vertical signals (HSYNC, VSYNC) and a pixel clock (CLK).

During a display period, the digital YUV data signal line is used to transmit digital YUV data from the DVD decoder 112 to the VGA controller 113. During a vertical blanking period, it is used to transmit video control data set in the video control data register 112a from the DVD decoder 112 to the VGA controller 113.

The video control data, particularly, the Progressive frame flag and Repeat First Field flag, are used to control the interlace/non-interlace converting operation executed by the VGA controller 113.

The VGA controller 113 has a simple field synthesizing mode and an interpolation mode as modes for the interlace/non-interlace conversion. In the simple field synthesizing mode, two pieces of field data consecutively input (even and odd fields) are synthesized into a piece of frame data. In the interpolation mode, missing lines of an input field (odd lines in an even field, and even lines in an odd field) are added by interpolation, thereby generating a piece of frame image from a piece of field image. In this case, for example, two consecutive lines of an input field are averaged with respect to every pixel, thereby obtaining a missing line which should exist between the two lines.

The simple field synthesizing mode and the interpolation mode are switched by means of the value of a Progressive Frame flag output from the DVD decoder 112. When the Progressive Frame flag is 0, i.e., when field data is decoded, the interpolation mode is used. When the Progressive Frame flag is 1, i.e., when frame data is decoded, the simple field synthesizing mode is used.

In the simple field synthesizing mode, the value of the Repeat First Field flag is used to determine whether the field data output from the DVD decoder 112 should be excluded from the field synthesizing process. More specifically, when the Repeat First Field flag is 1, the VGA controller 113 does not accept field data output next from the DVD decoder 112. As a result, the repeat field is skipped and excluded from the field synthesizing process. When the Repeat First Field flag is 0, consecutively input two fields are subjected to the synthesizing process.

Further, the VGA controller 113 includes a line designation register 113a having the same structure as that of the line designation register 112b provided in the DVD decoder 112. The line designation register 113a stores line designation information and clock designation information transmitted from the DVD decoder 112.

FIG. 3 shows a format of video control data set in the video control data register 112a.

As shown in FIG. 3, a Top/Bottom flag is set in a bit 7 of the video control data register 112a, a Progressive Sequence flag in a bit 6, a Progressive Frame flag in a bit 5, and a Repeat First Field flag in a bit 4. The video control data of these four bits are transmitted to the VGA controller 113 in a vertical blanking period.

In this case, the Top/Bottom flag in the bit 7 is used to inform the VGA controller 113 whether digital YUV data of a next field output from the DVD decoder 112 is top or bottom field data. The Progressive Sequence flag of the bit 6 is used to inform the VGA controller 113 whether the digital YUV data of the next field output from the DVD decoder 112 is progressive-scanned data.

The Progressive Frame flag in the bit 5 is used to inform the VGA controller 113 whether the digital YUV data of the next field output from the DVD decoder 112 is formed of progressive data (frame data) of 24 Hz. The VGA controller 113 performs switching between the interpolation mode and the field synthesizing mode in accordance with the value of the Progressive Frame flag.

The Repeat First Field flag in the bit 4 is used to inform the VGA controller 113 whether the digital YUV data of the next field output from the DVD decoder 112 is a repeat field. The VGA controller 113 executes a skip process for excluding the repeat field from the synthesizing process of the field synthesizing mode based on the value of the Repeat First Field flag.

FIG. 4 shows a structure of digital YUV data output from the DVD decoder 112 for use in the interlace display.

In general, a video signal for interlace display is constituted by 525 lines, from a line 1 to a line 525. The period of lines 22 to 263 are used to display even fields (E) and the period of lines 264 to 525 are used to display odd fields (O). The periods of lines 1 to 21 and 264 to 284 are vertical blanking periods (V_Blanking).

The aforementioned video control data of the four bits are output in, for example, the lines 2, 264, etc., in the vertical blanking period.

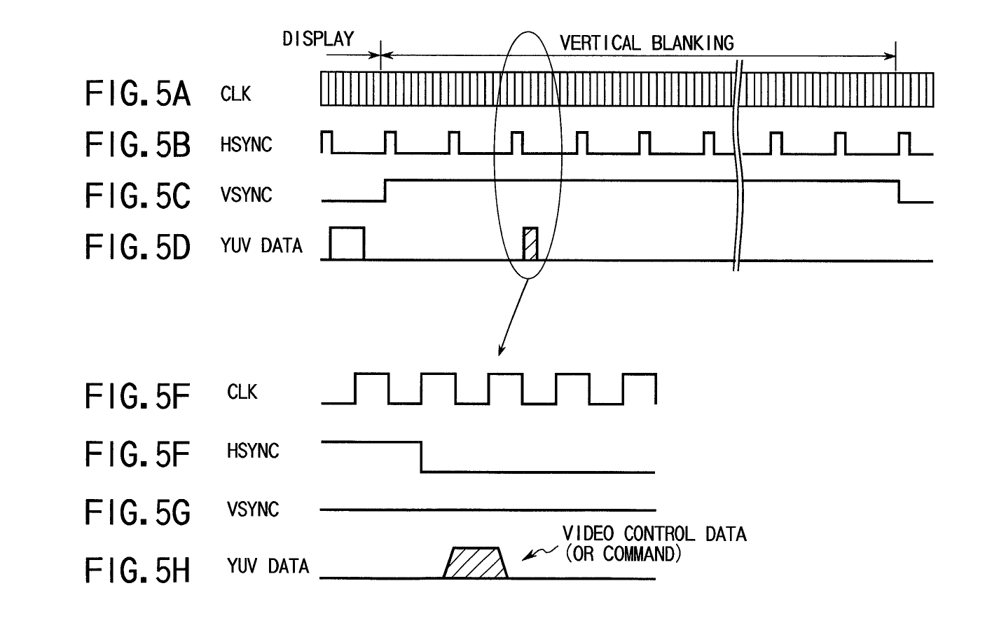

FIGS. 5A to 5H are timing charts showing transmission timing of video data from the DVD decoder 112 to the VGA controller 113 through a video bus constituted by a ZV port, etc.

During a period (Display) when a vertical sync signal (Vsync) is low in level, video signals of each field are output in units of pixel at every pixel clock in synchronism with a horizontal sync signal (Hsync) from a digital YUV data output terminal of the DVD decoder 112 connected to a digital YUV data signal line. During a vertical blanking period when the vertical sync signal (Vsync) is high in level, in the period of lines 2 and 264, video control data of four bits is output from the digital YUV data output terminal of the DVD decoder 112, and supplied to the VGA controller 113 through the digital YUV data signal line.

The VGA controller 113 analyzes data on the line 2 or 264 and switches to a display control mode optimal to the next field during the vertical blanking period.

Instead of transmitting the video control data to the VGA controller 113, it is possible that a command for controlling the display operation of the VGA controller 113 is generated in the DVD decoder 112 based on the video control data, and that the command is transmitted to the VGA controller 113 through the digital YUV data signal line during the vertical blanking period.

In this case, the DVD decoder 112 periodically checks the contents of the video control data register 112a at every vertical sync signal of the field data, generates a mode set command (Mode Set) for designating the conversion mode (the interpolation mode or simple field synthesizing mode) and a drop field command (Drop Field) for instructing the skip of field data, and transmits the commands to the VGA controller 113 through the digital YUV data signal line in the vertical blanking period.

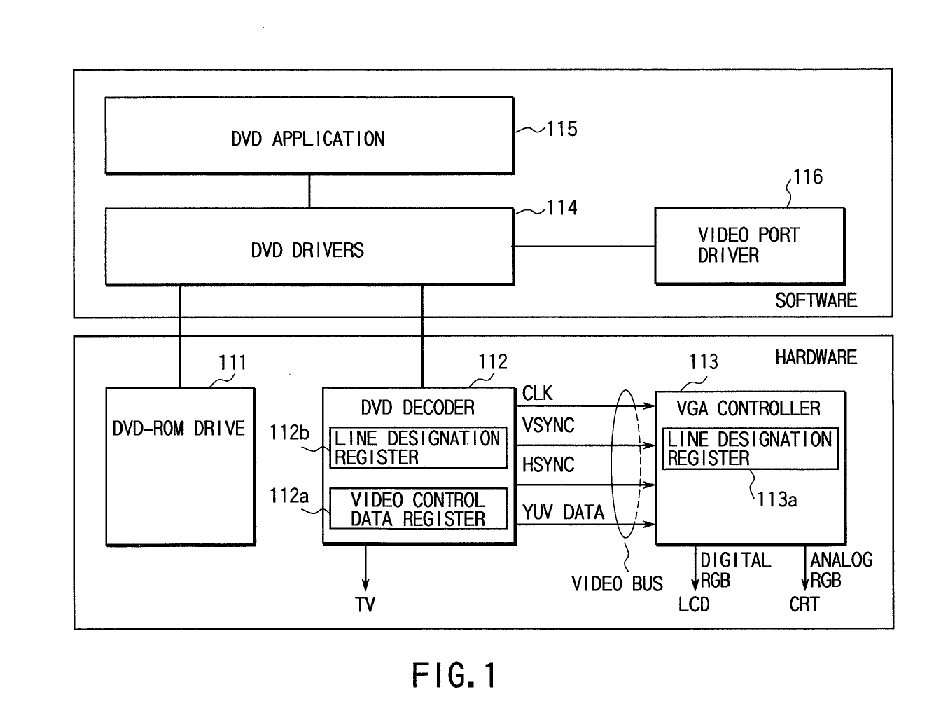

As described above, in the structure shown in FIG. 1, the DVD decoder 112 has the function of informing the VGA controller 113 of the video data structure of the data to be decoded and the output of a repeat field during the vertical blanking period. Thus, the interlace/non-interlace conversion function of the VGA controller 113 can be controlled timely, thereby displaying a smooth image without feathering on the display monitor of the computer. Further, since the vertical blanking period is utilized, the existing video bus, such as the ZV (Zoomed Video) port, can be used without providing an exclusive interface line for transmitting video control data or a command between the DVD decoder 112 and the VGA controller 113. The ZV port has been widely used as a video bus of a notebooktype personal computer, and various kinds of VGA controllers having a video input port applicable to the ZV port have been developed. Under the circumstances, the structure of the present invention is the most suitable to a personal computer, particularly, a notebook-type personal computer incorporating a DVD-ROM drive 112, since the control information for dynamically switching the display operation of the VGA controller 113 can be transmitted to the VGA controller 113, while the ZV port is utilized.

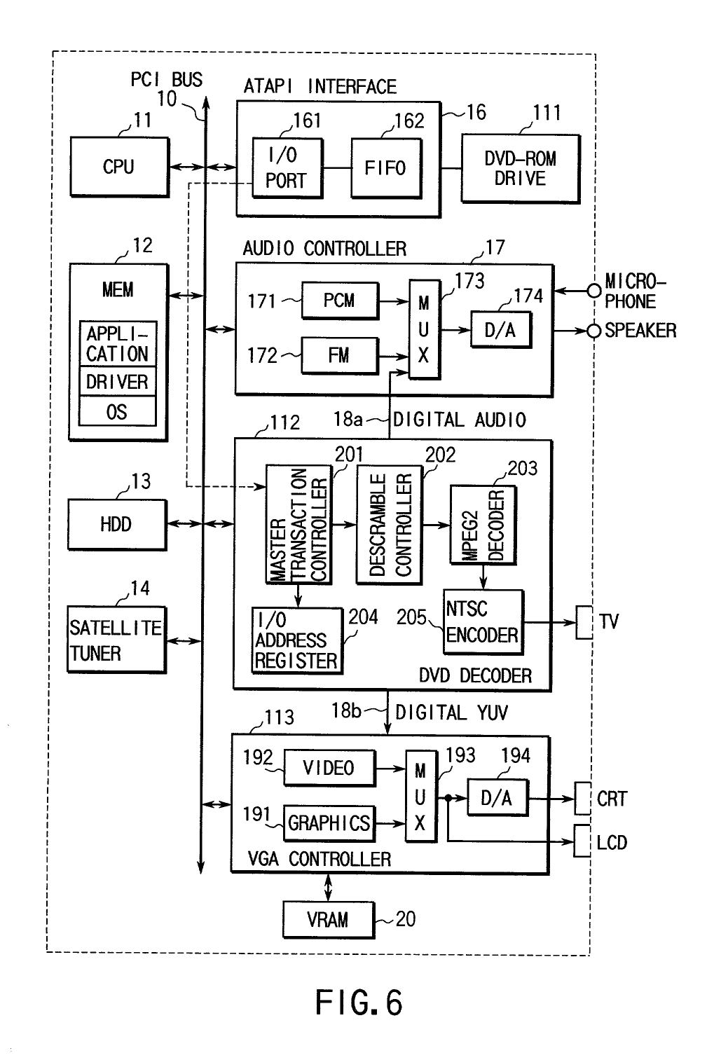

A concrete system structure of the personal computer of this embodiment will be described with reference to FIG. 6.

The system corresponds to a personal computer of notebook type. As shown in FIG. 6, the system comprises a PCI bus 10, a CPU 11, a main memory (MEM) 12, an HDD 13, a satellite tuner 14, a DVD interface 16 and an audio controller 17. It also comprises the aforementioned DVD-ROM drive 111, the DVD decoder 112 and the VGA controller 113.

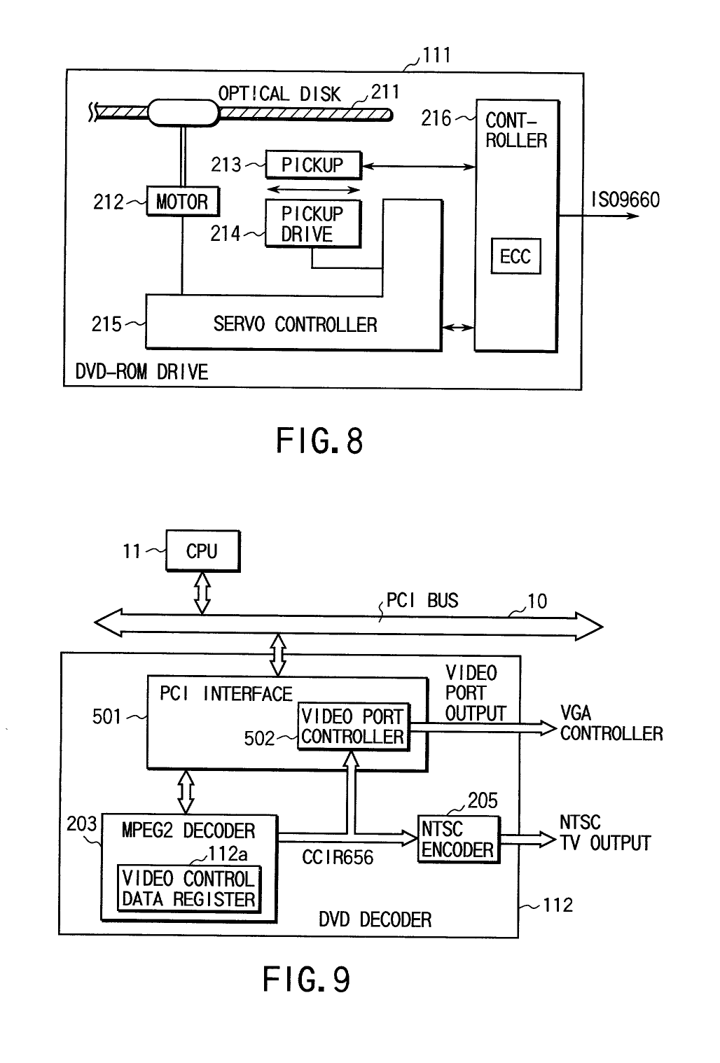

The DVD-ROM drive 111 reads a data stream stored in a DVD-ROM medium, having a memory capacity of about 10 GB on both sides of the disk, at a transfer rate of 10.8 Mbps at maximum. The DVD-ROM drive 111, as shown in FIG. 8, comprises a DVD medium 211 constituted by an optical disk, a motor 212, a pickup 213, a pickup drive 214, a servo controller 215 and a drive controller 216 including an ECC circuit for detecting and correcting errors. The motor 212, the pickup 213, the pickup drive 214, the servo controller 215 and the drive controller 216 function as a driving device for driving the DVD medium 211 and reading data from the DVD medium 211.

The DVD-ROM medium 211 is capable of storing, for example, movie data of about 135 minutes on a single side. The movie data can include a main image (video data), a sub image (sub-picture data) up to 16 channels, and a sound (audio data) up to 32 channels.

In this case, the video, sub-picture and audio data are recorded as coded data which are digital-compression coded in accordance with the MPEG2 standard. According to the standard, the MPEG2 coded data can contain other kinds of coded data, and these coded data are treated as a single MPEG2 program stream.

The MPEG2 system is used to code the video data, while the run-length encoding system and the DOLBY AC-3 system are used to code the sub-picture and audio data. In this case also, coded video, sub-picture and audio data are treated as a single MPEG2 program stream.

The coding process in accordance with the MPEG2 standard is variable rate coding, in which the amount of information recorded/reproduced in unit time can be varied. Therefore, a quality animation image can be reproduced by increasing the transmission rate of the MPEG streams constituting frames in accordance with the increase in speed of movement in the scene.

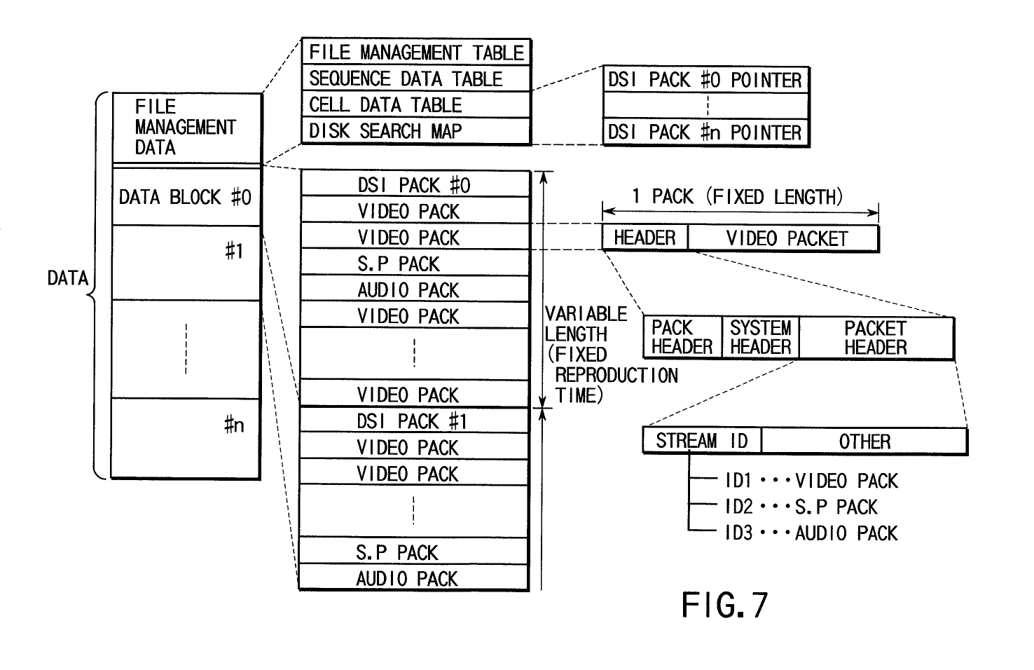

To utilize the advantage of the MPEG2 system, in this embodiment, the data format as shown in FIG. 7 is used to record titles of a movie or the like in the DVD medium 211.

As shown in FIG. 7, a title is constituted by a file management data section and a data section. The data section includes a number of data blocks (blocks #0-#n). Each data block has a DSI (Disk Search Information) pack in the top portion thereof. The portion where the DSI pack is stored is managed by disk search map data in the file management data section.

One data block constitutes information of 15 frames necessary to reproduce an animation image for a predetermined period, e.g., 0.5 second, and corresponds to a GOP (Group of Picture). Each data block stores multiplied data of video packs (VIDEO packs), sub-picture packs (S.P packs) and audio packs (AUDIO packs). The video pack (VIDEO pack), sub-picture pack (S.P pack) and audio pack (AUDIO pack) are units of coded video, sub-picture and audio data, respectively. The data sizes of these packs, corresponding to the sector sizes, are fixed. However, the number of packs which can be included in one data block is variable. Therefore, the higher the speed of the movement in the scene, the more the number of video packs included in the data block of the scene.

Each of the video pack, the sub-picture pack and the audio pack is constituted by a header portion and a packet portion (video packet, sub-picture packet and audio packet). The packet portion is the very coded data. The header portion is constituted by a pack header, a system header and a packet header. A stream ID representing that the corresponding packet is a video packet, a sub-picture packet or an audio packet is registered in the packet header.

As regards coded data recorded in the DVD, for example, coded data of a desired sector is scrambled by using a predetermined encryption algorithm, so that an unauthorized copy of the title can be prevented.

The DVD has a multi-story function and a multi-angle function. With the multi-story function, scenes corresponding to one of a plurality of scenarios designated by the user are selectively reproduced. With the multi-angle function, images corresponding to one of a plurality of different photographing angles designated by the user are selectively reproduced.

These functions are achieved as follows: a plurality of images corresponding to the multi-story or multi-angle are multiplied in units of data block, and the positions and the relationship between data blocks are managed in respect of each story or angle by means of the disk search map information.

The units included in the system shown in FIG. 6 will now be described.

The CPU 11, for controlling the operations of the overall system, executes an operation system stored in the system memory (main memory) (MEM) 12 and an application program to be executed. Transmission and reproduction of data stored in the DVD-ROM medium are executed by causing the CPU to operate the DVD drivers 114, the DVD application program 115 and the video port driver 116.

The DVD interface 16 is connected to an extension bay called a selectable bay for selectively connecting IDE/ATAPI devices, such as a CD-ROM drive, the DVD-ROM drive 111 and a second HDD for extension, to the main body of the computer. The DVD interface 16 transmits data between the computer and the device (the DVD-ROM drive 111 in this embodiment) connected to the selectable bay. The DVD interface 16 comprises a FIFO buffer 162 for temporarily storing data read out from the DVD-ROM drive 111 and an I/O port 161 for reading the data from the FIFO buffer 162 onto the PCI bus 10. The I/O port 161 is constituted by an I/O register which can be read by a bus master device for issuing an I/O transaction to the PCI bus 10.

The audio controller 17, for controlling input/output of sound data under the control of the CPU 11, comprises a PCM sound source 171, an FM sound source 172, and a multiplexer 173 and a D/A converter 174. The multiplexer 173 receives outputs from the PCM sound source 171 and the FM sound source 172 and digital audio data transferred from the DVD decoder 112, and selects one of the received output and the audio data.

Digital audio data is obtained by decoding audio data output from the DVD-ROM drive 111. The digital audio data is transferred from the DVD decoder 112 to the audio controller 17 through an audio bus 18a, not the PCI bus 10. Thus, high-speed transference of the digital audio data is achieved without influence on the performance of the computer system.

The DVD decoder 112 reads an MPEG2 program stream from the DVD interface 16 under the control of the CPU 11. The program stream is divided into video, sub-picture and audio packets, which are individually decoded and output in synchronism. The DVD decoder 112 is realized by a chip set mounted on a system board of the computer system. As shown in FIG. 6, the DVD decoder 112 comprises a master transaction controller 201, a descramble controller 202, an MPEG2 decoder 203 and an I/O address register 204.

The master transaction controller 201 causes the DVD decoder 112 to function as a bus master (initiator) for issuing transactions on the PCI bus 10. It executes I/O read transaction for reading animation data from the DVD interface 16. In this case, the I/O read transaction is constituted by an address phase for designating the I/O port 161 of the DVD interface 16 and at least one data transfer phase subsequent thereto, so that the animation data can be read by burst transmission. The I/O address value for designating the I/O port 161 is set to the I/O address register 204 by the CPU 11.

The MPEG2 program stream read by the master transaction controller 201 is transmitted to the MPEG2 decoder 203 via the descramble controller 202. The descramble controller 202 executes a descramble process, by which scrambled data included in the MPEG2 program stream is descrambled and returned to the original data. The MPEG2 decoder 203 divides the MPEG2 stream into video, sub-picture and audio packets and decodes these packets.

The decoded audio data is transferred as digital audio data to the audio controller 17 through the audio bus 18a, as described above. The decoded video and sub-picture data are synthesized and transmitted as digital YUV data to the VGA controller 113. In this case, as described before, the exclusive video bus 18b, not the PCI bus 10, is used to transfer the digital YUV data from the DVD decoder 112 to the VGA controller 113. Thus, high-speed transference of the digital YUV data is achieved without influence on the performance of the computer system, as in the case of the digital audio data. ZV ports can be used as the audio bus 18a and the video bus 18b.

The DVD decoder 112, incorporating an NTSC encoder 205, also has a function of converting digital YUV data and audio data to TV signals of the NTSC system and outputting them to an external TV receiver.

The VGA controller 113 controls an LCD or an external CRT display used as a display monitor of the system under the control of the CPU 11, and supports animation display in addition to display of text and graphics of the VGA specification.

As shown in FIG. 6, the VGA controller 113 comprises a graphics display control circuit (GRAPHICS) 191, a video display control circuit 192, a multiplexer 193 and a D/A converter 194.

The graphics display control circuit 191, serving as a VGA compatible graphic controller, converts VGA graphics data written in a video memory (VRAM) 20 into RGB video data and outputs the converted data. The video display control circuit 192, serving as an interface between the digital video input port and the VGA controller 113, has a function of interlace/non-interlace conversion using the video memory (VRAM) 20 or a video buffer in the video display control circuit 192. The video display control circuit 192 includes a YUV-RGB converter for converting YUV data, which has been converted to frame data for use in the non-interlace display, into RGB video data.

The multiplexer 193 either selects one of the graphics display control circuit 191 and the video display control circuit 192 or synthesizes a video output from the video display control circuit 192 on VGA graphics output from the graphics display control circuit 191 and outputs the synthetic output to the LCD. The D/A converter 194 converts video data from the multiplexer 193 to an analog RGB signal and displays it to the CRT display.

The satellite tuner 14 receives image data transmitted by a digital satellite broadcast and transfers it to the main memory 12. When image data obtained by the digital satellite broadcast is constituted by MPEG2 streams, the data is decoded by the MPEG2 decoder 203 of the DVD decoder 112, as in the case of video data read out from the DVD-ROM drive 111.

FIG. 9 shows interconnection between units constituting the DVD decoder 112.

A PCI interface unit 501 shown in FIG. 9 comprises the aforementioned master transaction controller 201, descramble controller 202 and I/O address register 204. The MPEG2 program stream descrambled by the PCI interface unit 501 is input to the MPEG2 decoder 203 and decoded therein. In this case, the MPEG2 decoder 203 interprets the aforementioned Top/Bottom flag, Progressive Sequence flag, Progressive Frame flag and Repeat First Field flag, and proceeds to the decoding operation in accordance with the result of the interpretation. These flags are set in the video control data register 112a and also used to control the VGA controller 113 as described before.

The video data decoded by the MPEG2 decoder 203 is input to the NTSC encoder 205 and a video port controller 502 of the PCI interface unit 501. The video port controller 502 converts the video data output from the MPEG2 decoder 203 to a data format which can be output to the video port of the VGA controller 113. It outputs the vertical sync signal (Vsync), horizontal sync signal (Hsync), pixel clock (CLK) and digital YUV data to the video port of the VGA controller 113. In the vertical blanking period, the video port controller 502 outputs the contents of the video control data set in the video control data register 112a to the video port of the VGA controller 113 through the digital YUV signal line. The video port controller 502 has a register for programmably setting transmission timing of the video control data. The register allows transmission of the video control data as arbitrary line data in the vertical blanking period. The video control data can be transmitted not only in the vertical blanking period but also in the horizontal blanking period.

A concrete operation for controlling the interlace/non-interlace conversion will be described.

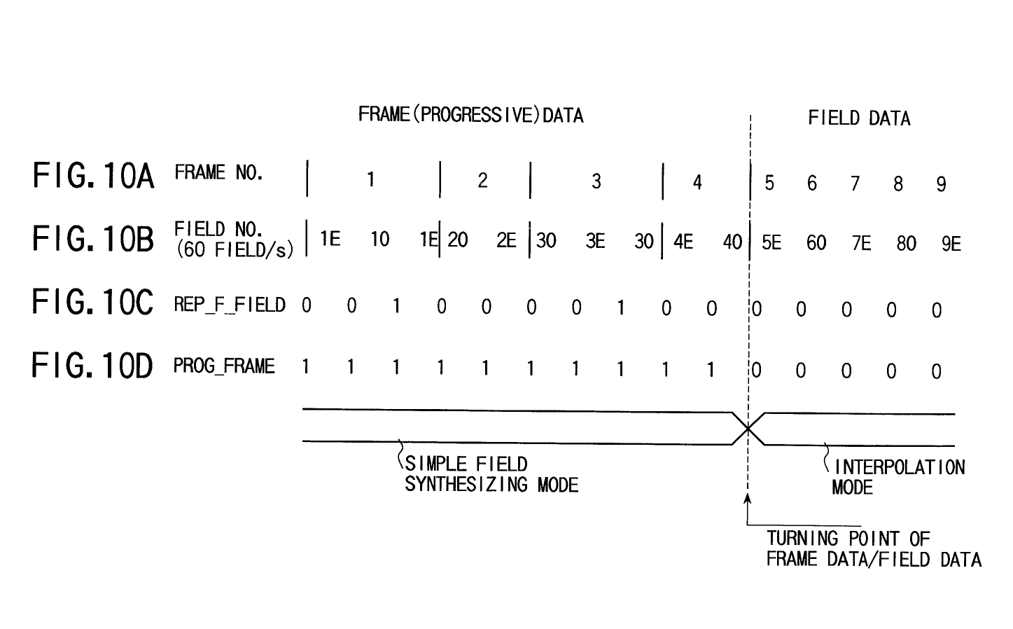

First, interlace/non-interlace conversion control to solve the aforementioned field image problem will be described with reference to FIGS. 10A to 10D.

To display field data, as described above, the conversion mode of the VGA controller 113 is set to the interpolation mode, and lines missing from each field image (odd lines in an even field, and even lines in an odd field) are added to the field image. As a result, it is possible to generate and display one frame image from one field image, thereby preventing synthesis of fields having a time difference. However, some titles include both frame data (progressive data) and field data, in which case, it is necessary to switch the conversion mode dynamically from the simple field synthesizing mode to the interpolation mode, while the titles are being reproduced. By the switching, Field data can be displayed without feathering. The switching method will now be described.

FIGS. 10A to 10D show the relationship between the switching of frame data (progressive data) and field data and the switching of the conversion mode.

In FIGS. 10A to 10D, “Frame No.” represents the frame numbers of frame data (24 frames/second) and field data (60 fields/second) before decoding. “Field No.” represents the field number of decoded field data (60 fields/second) adapted for the NTSC. The letters E and O suffixed to the field numbers respectively represent even and odd fields.

In a period of decoding frame data (24 frames/second), the Progressive Frame flag (Prog_Frame) is set to “1”. When the period of decoding the frame data is switched to a period of decoding field data, the Progressive Frame flag (Prog_Frame) is reset to “0”.

The DVD decoder 112 discriminates whether the video data to be decoded is field data or frame data based on the Progressive Frame flag included in the MPEG2 program stream, while it is decoding the video data. In the decode process of frame data, the frame rate is also adjusted by the 3:2 pull down conversion. In the vertical blanking period, the video port control circuit 502 of the DVD decoder 112 transmits the Progressive Frame flag (Prog_Frame) to the VGA controller 113 to inform whether field data output next is frame data or field data.

When the VGA controller 113 samples a Progressive Frame flag signal output in the vertical blanking period from the video port controller 502 of the DVD decoder 112, and detect that the Progressive Frame flag signal is asserted to “1”, the VGA controller 113 performs interlace/non-interlace conversion in the next field, using the simple field synthesizing mode. When it detects that the Progressive Frame flag signal is deasserted to “0”, it changes the conversion mode to the interpolation mode in the next field.

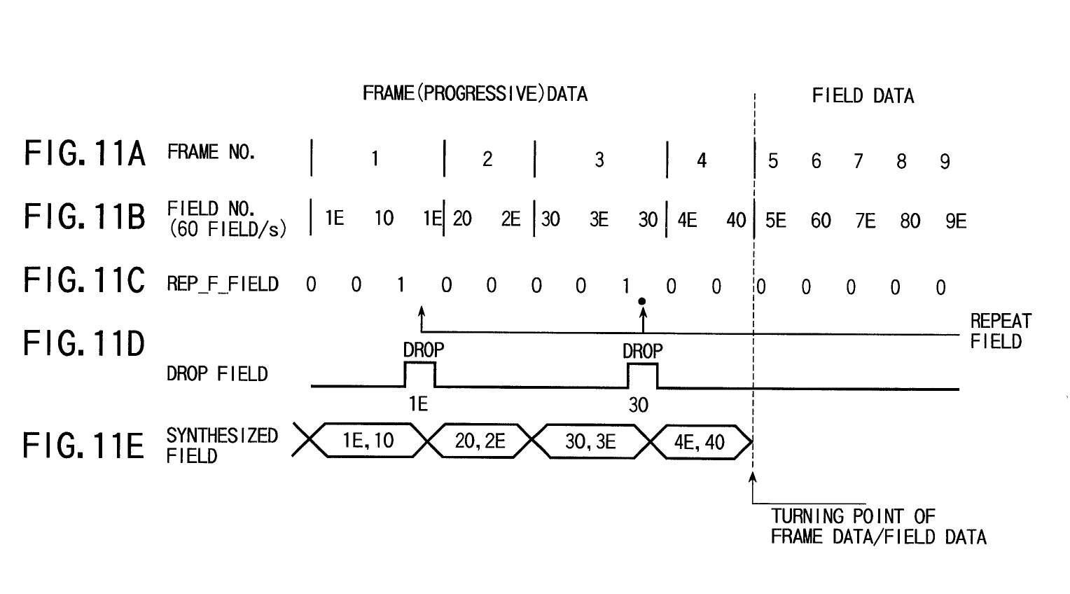

Interlace/non-interlace conversion control to solve the aforementioned repeat field program will now be described with reference to FIGS. 11A to 11E.

In the case of decoding frame data (progressive data) of 24 frames/second, the frame data of 24 frames/second is converted to field data of 60 fields/second by the method called 3:2 pull down. In the 3:2 pull down conversion, as shown in FIGS. 11A to 11E, the third field of the first frame is a repeat of the first field (1E), and the third field of the third frame is also a repeat of the first field (3O).

In the simple field synthesizing process, there is a problem about a combination of field data generated from frame data of different frame numbers. Therefore, the repeat field problem can be solved by skipping the repeat field from the object of the simple field synthesizing process. A repeat field can be skipped as follows.

When video data to be decoded is frame data, the DVD decoder 112 discriminates the timing of generating a repeat field based on the Repeat First Field flag included in the MPEG2 program stream and decodes the video data, while performing the frame rate adjustment required by the 3:2 pull down conversion. In FIGS. 11A to 11E, the timings of the Repeat First Field flag and the repeat field coincide with each other, to make the explanation simple. Actually, however, the Repeat First Field flag is set in the latter half of the first field which is to be repeated, and reset in the former half of the second field.

The video port controller 502 transmits the Repeat First Field flag to the VGA controller 113 to inform whether the field data output next is a repeat field or not, during the vertical blanking period.

When the VGA controller samples a Repeat First Field flag signal output in the vertical blanking period from the video port controller 502 of the DVD decoder 112, and detect that the signal is asserted to “1”, the VGA controller 113 does not capture the next field, i.e., the repeat field. As a result, the repeat field becomes a drop field which is excluded from the object of the field synthesis. Thus, the simple field synthesizing process is performed with respect to only the combination of two fields of the same frame number.

More specifically, referring to FIGS. 11A to 11E, the VGA controller 113 first generates a piece of frame from the first field (1E) and the second field (1O) of the first frame. It does not capture the data of the repeat field, i.e., the third field (1E) of the first frame. Then, it generates a second frame from the first field (2E) and the second field (2O) of the second frame. Thus, the repeat field is skipped, thereby obtaining an image without feathering.

Although the control operation in the case of non-interlace display of MPEG2 stream data output from the DVD-ROM drive 111 has been described above, the present invention can be applied to the case of non-interlace display of MPEG2 stream data received by the satellite tuner 14. In the latter case also, video control data or commands are transmitted from the DVD decoder 112 to the VGA controller 113 through the YUV signal line in the vertical blanking period.

Although the personal computer has been described above as an example, the method for transmitting display control information from a DVD decoder to a display controller utilizing a blanking period can be applied to a word processor, a work station, a set top box, a DVD player for civil use, and a game machine.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

1. A computer system comprising:
a decoder for decoding a series of data and outputting a video signal;
a display controller, having a video input port to which the video signal output from the decoder is input, for displaying the video signal input to the video input port based on display control information; and
display control information transmitting means for transmitting the display control information to the video input port of the display controller through a video signal line for transmitting the video signal, during a blanking period of the video signal transmitted from the decoder to the video input port of the display controller.

2. The system according to claim 1, wherein:
the series of data includes discriminating information indicating a structure of data included in the series of data as information for controlling a decoding process of the decoder; and
the display control information transmitting means transmits the discrimination information as the display control information to the video input port of the display controller during a vertical blanking period of the video signal transmitted from the decoder to the video input port of the display controller.

3. The system according to claim 1, wherein:
the series of data includes discriminating information indicating a structure of data included in the series of data as information for controlling a decoding process of the decoder; and
the display control information transmitting means converts the discriminating information to a command for controlling a display control operation of the display controller and transmits the command as the display control information to the video input port of the display controller during a vertical blanking period of the video signal transmitted from the decoder to the video input port of the display controller.

4. The system according to claim 1, wherein:
during a vertical blanking period of the video signal transmitted from the decoder to the video input port of the display controller, the display control information transmitting means transmits information, representing whether a video signal of a next field output from the decoder to the display controller is obtained from a series of coded data of a field data structure or frame data structure, to the video input port of the display controller as the display control information; and
the display controller comprises converting means for converting data for use in interlace display to data for use in non-interlace display using one of conversion modes of a field synthesizing mode for synthesizing an even field and odd field to generate a frame for use in non-interlace display and an interpolation mode for interpolating an even or odd line missing from each field to generate a frame for use in non-interlace display, and switches the conversion modes in accordance with the display control information.

5. The system according to claim 4, wherein:
the display control information transmitted to the video input port of the display controller by the display control information transmitting means further includes information representing whether the video signal of the next field output from the decoder to the display controller is a repeat field generated by 3:2 pull down conversion; and
when the video signal of the next field output from the decoder to the display controller is a repeat field, the display controller excludes the video signal corresponding to the repeat field from a process of converting the field synthesizing mode.

6. The system according to claim 1, wherein the display control information comprise:
information representing whether a video signal of a next field output from the decoder is a top field or a bottom field;
information representing whether the video signal of the next field output from the decoder is progressive sequence data;
information representing whether the video signal of the next field output from the decoder is frame data; and
information representing whether the video signal of the next field output from the decoder is a repeat field.

7. The system according to claim 6, wherein the video signal is digital YUV data.

8. The system according to claim 1, wherein the series of data are digital-compression coded data.

9. The system according to claim 1, wherein the decoder has a register for designating in synchronism with what clock of what line of a blanking period of the video signal the display control information is transmitted to the video input port of the display controller.

10. The system according to claim 9, wherein the display controller has a register for designating in synchronism with what clock of what line of a blanking period of the video signal the display control information is transmitted to the video input port of the display controller.

11. A computer system for decoding a series of data including discriminating information indicating a structure of data, said apparatus comprising:
means for extracting the discriminating information from the series of data and decoding the series of data based on the discriminating information;
means for outputting a video signal obtained by the decoding means through a video signal output terminal; and
means for outputting, during a blanking period of the video signal, the extracted discriminating information or a display control command generated from the discriminating information as control information for controlling display of the video signal through the video signal output terminal.

12. The system according to claim 11, wherein the control information includes:
information representing whether a video signal of a next field output from the animation image decoding apparatus is obtained from coded data of a field data structure or frame data structure; or
information representing whether a video signal of a next field output from the animation image decoding apparatus is a repeat field generated by 3:2 pull down conversion.

13. The apparatus according to claim 11, further comprising a register for designating in synchronism with what clock of what line of a blanking period of the video signal the discriminating information or the display control command is output.

14. The apparatus according to claim 11, wherein the data is digital-compression coded data.

15. A display control method of a display controller having a video input port, comprising the steps of:
decoding a series of data and outputting a video signal;
inputting the video signal and displaying the input video signal based on display control information; and
transmitting the display control information to the video input port of the display controller through a video signal line for transmitting the video signal, during a blanking period of the video signal.

16. The method according to claim 15, wherein:
the series of data includes discriminating information indicating a structure of data included in the series of data as information for controlling the decoding step; and
the transmitting step transmits the discrimination information as the display control information to the video input port of the display controller during a vertical blanking period of the video signal.

17. The method according to claim 15, wherein:
the series of data includes discriminating information indicating a structure of data included in the series of data as information for controlling a decoding process of the decoder; and
the transmitting step converts the discriminating information to a command for controlling a display control operation of the display controller and transmits the command as the display control information to the video input port of the display controller during a vertical blanking period of the video signal.

18. The method according to claim 15, wherein:
during a vertical blanking period of the video signal, the transmitting step transmits information, representing whether a video signal of a next field is obtained from a series of coded data of a field data structure or frame data structure, to the video input port of the display controller as the display control information; and further comprises:
converting data for use in interlace display to data for use in non-interlace display using one of conversion modes of a field synthesizing mode for synthesizing an even field and odd field to generate a frame for use in non-interlace display and an interpolation mode for interpolating an even or odd line missing from each field to generate a frame for use in non-interlace display, and switches the conversion modes in accordance with the display control information.

19. The method according to claim 18, wherein:
the display control information further includes information representing whether the video signal of the next field is a repeat field generated by 3:2 pull down conversion; and further comprises the step of:
excluding, when the video signal of the next field is a repeat field, the video signal corresponding to the repeat field from a process of converting the field synthesizing mode.

20. The method according to claim 15, wherein the display control information comprise:
information representing whether a video signal of a next field is a top field or a bottom field;
information representing whether the video signal of the next field is progressive sequence data;
information representing whether the video signal of the next field is frame data; and
information representing whether the video signal of the next field is a repeat field.

21. The method according to claim 20, wherein the video signal is digital YUV data.

22. The method according to claim 15, wherein the series of data are digital-compression coded data.

23. The method according to claim 15, wherein the decoding step further includes the step of designating in synchronism with what clock of what line of a blanking period of the video signal the display control information is transmitted to the video input port of the display controller.

24. A method for decoding a series of data including discriminating information indicating a structure of data, said method comprising the steps of:
extracting the discriminating information from the series of data and decoding the series of data based on the discriminating information;
outputting externally a video signal obtained by the decoding step; and
outputting externally, during a blanking period of the video signal, the extracted discriminating information or a display control command generated from the discriminating information as control information for controlling display of the video signal.

25. The method according to claim 14, wherein the control information includes:
information representing whether a video signal of a next field is obtained from coded data of a field data structure or frame data structure; or
information representing whether a video signal of a next field is a repeat field generated by 3:2 pull down conversion.

26. The method according to claim 25, further comprising the step of designating in synchronism with what clock of what line of a blanking period of the video signal the discriminating information or the display control command is output.

27. The method according to claim 24, wherein the data is digital-compression coded data.
